(19) United States
(12) Patent Application Publication
(10) Pub. No.: US 2007/0082648 A1
(43) Pub. Date: Apr. 12, 2007

(54) Powering down inphase or quadrature related components

(75) Inventor: Timothy Leo Gallagher, Encinitas, CA (US)

Correspondence Address: VAN PELT, YI & JAMES LLP, 10050 N. FOOTHILL BLVD #200, CUPERTINO, CA, 95014, US

(73) Assignee: Staccato Communications, Inc.

(21) Appl. No.: 11/281,255

(22) Filed: Nov. 16, 2005

Related U.S. Application Data
(60) Provisional application No. 60/724,824, filed on Oct. 6, 2005.

(51) Int. Cl. H04B 1/16; H04B 1/38

(52) U.S. Cl. 455/343.2; 455/574

(57) ABSTRACT

Operating a signal processor is disclosed. A first signal processor and a second signal processor are simultaneously operating. The first signal processor is associated with processing a first component of a signal received via a wireless medium, and the second signal processor is associated with processing a second component of the signal received via the wireless medium. It is determined whether to suspend operation of the second signal processor. Operation of the second signal processor is suspended.

### CROSS REFERENCE TO OTHER APPLICATIONS

This application claims priority to U.S. Provisional Patent Application No. 60/724,824 entitled REDUCED PROCESSING WIRELESS DEVICES filed Oct. 6, 2005 which is incorporated herein by reference for all purposes.

### BACKGROUND OF THE INVENTION

Transmit and receive processes are used by wireless devices to generate a transmission signal and obtain data from a received signal, respectively. Transmit and receive processes may be described by a specification, including ultrawideband (UWB) specifications (such as WiMedia and IEEE 802.15.3a) and narrowband specifications (such as WiFi (IEEE 802.11) and WiMax). In some applications, reduced power consumption wireless devices or smaller wireless devices may be attractive. Reduced processing methods may enable such wireless devices.

### BRIEF DESCRIPTION OF THE DRAWINGS

Various embodiments of the invention are disclosed in the following detailed description and the accompanying drawings.

FIG. 1 is a block diagram illustrating an embodiment of a wireless device.

FIG. 2 is a block diagram illustrating an embodiment of a baseband transmitter.

FIG. 3 is a block diagram illustrating an embodiment of a baseband receiver.

FIG. 4 is a diagram illustrating an embodiment of a frame, portions of which reduced processing is performed on.

FIG. 5 is a transmission diagram illustrating an embodiment of reduced processing of symbols.

FIG. 6 is a flowchart illustrating an embodiment of reduced processing of symbols.

FIG. 7 is a spectrum illustrating an embodiment of reduced processing applied to encoded data.

FIG. 8 is a spectrum illustrating an embodiment of reduced processing applied to frequency spread subcarriers.

FIG. 9 is a flowchart illustrating an embodiment of reduced processing applied to frequency spread subcarriers.

FIG. 10 is a flowchart illustrating an embodiment of disabling a Q path after adjusting a local oscillator.

FIG. 11 is a block diagram illustrating an embodiment of a dither loop used to adjust a phase of a receiver's local oscillator.

FIG. 12 is a flowchart illustrating an embodiment of disabling a Q path after adjusting a filter.

FIG. 13 is a block diagram illustrating an embodiment of a radio receiver that uses an adjustable filter to compensate for a channel response.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A method of operating a signal processor is disclosed. A first signal processor and a second signal processor are simultaneously operated. Each processor is associated with processing a component of a received signal. It is determined whether to suspend operation of the second signal processor and operation of the second signal processor is suspended. In some embodiments, the first component contains substantially more signal energy than the second component. For example, most of the signal energy may be in either the Inphase (I) signal or the Quadrature (Q) signal for some data rates. The processor associated with the component with most of the signal energy may be operated and operation of the other processor may be suspended. In some embodiments, methods may be employed to facilitate tracking when operation of the second signal processor is suspended.

It may be desirable for a wireless device to perform reduced processing in certain cases. In some embodiments, reduced processing takes advantage of a distribution of information. For example, some data rates introduce redundancy in the frequency domain and/or the time domain. Rather than processing all data, some of which may include redundant information, a subset of data may be processed. Two wireless devices may be located relatively close to each other and the additional performance gain from processing the redundant information may not be needed. In another example, at some data rates, most of the signal energy is in one component (such as an I signal) of a received signal. There may be little benefit from processing the component with minimal signal energy.

Reduced processing may facilitate reduced power consumption or smaller devices. A number of reduced processing embodiments are described herein and benefits, such as reduced power consumption or smaller size, may be associated with the embodiments. In some embodiments, additional steps are not needed to reduce power consumption. In some embodiments, a step of powering down a component may be used to reduce power consumption. An appropriate power down method may vary depending on the component. For example, powering down may consist of turning off a power supply, reducing/stopping a reference clock, or switching a component into a lower power state. Although it may not necessarily be discussed specifically with reference to each embodiment, the embodiments described may be associated with reduced power consumption.

Reduced processing may facilitate smaller devices. Less data or signals are processed, and components performing reduced processing may be reduced or eliminated. The components reduced or eliminated may be associated with the transmit path or the receive path of the wireless device. Smaller wireless devices may be attractive in some applications where consumers are sensitive to price, or where performance is not a major consideration.

Reduced processing methods may be embodied in a variety of wireless devices. In some embodiments, a wireless device switches between full processing and reduced processing. The wireless device may decide whether to perform reduced processing on a frame by frame basis, although switching between reduced and full processing may not necessarily coincide with a frame boundary. In some embodiments, wireless devices always perform reduced processing. For example, a receiver may be fixed to always process a subset of received data.

Determining whether to perform reduced processing may be based on a variety of factors. In some embodiments, power consumption is evaluated. If power consumption is a concern, a transmitter or receiver may perform reduced processing to conserve power. In some embodiments, deciding to perform reduced processing is based on a performance measurement. A wireless device may have a low error rate. The wireless may decide to transition to a reduced processing mode since performance is more than sufficient. In some embodiments, deciding to perform reduced processing is based on a data rate associated with a frame. Other factors may be used to determine whether to perform reduced processing.

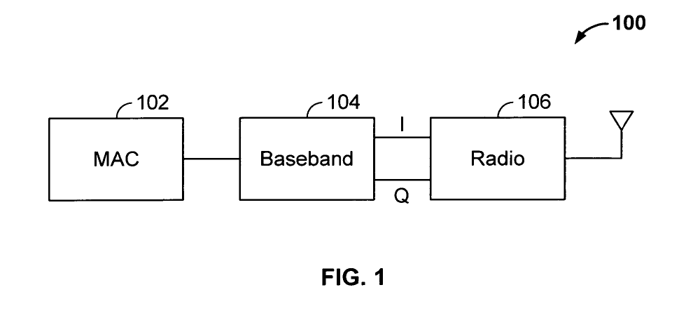

FIG. 1 is a block diagram illustrating an embodiment of a wireless device. In the example shown, wireless device 100 may be an ultrawideband (UWB) or a narrowband wireless device. Some example UWB wireless devices include WiMedia devices and IEEE 802.15.3a devices. WiFi (IEEE 802.11) and WiMax (IEEE 802.16) are some example narrowband wireless devices.

During transmission, Medium Access Controller (MAC) 102 passes transmit data to baseband 104. Baseband 104 may also be referred to as a PHY. A data rate associated with the transmit data may be passed to baseband 104. Baseband 104 processes the transmit data, for example, by encoding, modulating, and interleaving the frame. Overhead information, such as a preamble and header, may be added to the transmit data, and the resulting frame may be divided into symbols. Analog I and Q signals are passed from baseband 104 to radio 106. Radio 106 transmits I and Q signals from baseband 104 on an appropriate band. For example, if wireless device 100 is a WiMedia wireless device, a band may be 528 MHz wide. A WiMedia wireless device may select a band from multiple possible bands, each band of which is approximately in the range of 3.4 GHz to 10.3 GHz. Each WiMedia band includes 100 subcarriers used to transmit data. Other subcarriers may be used to carry overhead information, such as pilot tones and guard tones. In some embodiments, Fixed Frequency Interleaving (FFI) is used and symbols of a frame are transmitted on one band. In some embodiments, Time Frequency Interleaving (TFI) is used and multiple bands are used to transmit symbols of a frame.

Corresponding inverse processes may be applied when receiving. Radio 106 may tune to an appropriate band at an appropriate time to obtain received I and Q signals. The received I and Q signals may be passed to baseband 104 for processing. Baseband 104 may process the I and Q signals to obtain receive data. Additional processing may also be applied, some of which may not necessarily have a corresponding transmit process. For example, baseband 104 may synchronize to the timing of the transmitter to receive symbols of a frame. Timing related components in a transmitter or a receiver may be non-ideal so a receiver may adjust its timing over the duration of receiving a frame. Receive data is passed from baseband 104 to MAC 102.

In some embodiments, a receiver portion of wireless device 100 performs reduced processing and the transmitter portion does not. This may be attractive in some applications where a specification, such as the WiMedia specification, defines on-air transmissions between wireless devices. A wireless device that employs reduced processing in its receiver and not its transmitter may be compliant with the specification.

In some embodiments, a transmitting portion of wireless device 100 performs reduced processing. In some embodiments, a transmitter communicates information associated with reduced processing to a receiver. For example, a transmitter may tell a receiver which information was not processed and/or not transmitted. A receiver may use this communicated information to determine receiver processing to apply or to make decisions about received data. A variety of mechanisms may be used to communicate this information. For example, a header of a frame may be used or a defined frame may be used.

In some embodiments, baseband 104 and/or radio 106 are associated with reduced processing. The following figures illustrate embodiments of a baseband transmitter and a baseband receiver that may perform reduced processing.

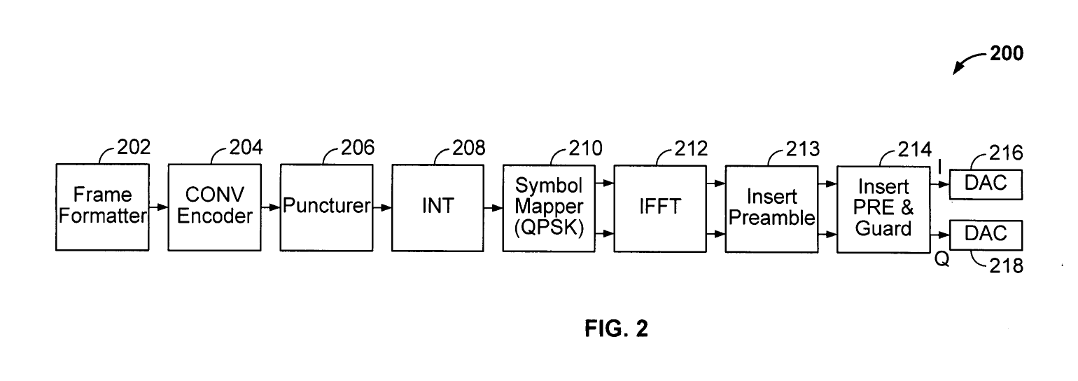

FIG. 2 is a block diagram illustrating an embodiment of a baseband transmitter. In the example shown, the baseband transmitter is a WiMedia device, although other types of basebands may be used. Processes performed by baseband transmitter 200 may depend on a data rate associated with a frame. Baseband transmitter 200 includes frame formatter 202. Frame formatter 202 may receive transmit data from a MAC. Overhead information such as a header may be added to the transmit data and processing such as scrambling may be performed by frame formatter 202. Convolutional encoder 204 encodes data from frame formatter 202. A ⅓ code rate may be used at some data rates where three encoded bits are generated for every one input bit. Encoded data from encoder 204 is passed to puncturer 206. Puncturer removes certain encoded data based on the data rate and modifies the code rate. The punctured data is passed to interleaver 208 for reordering. Interleaving may be within symbol boundaries or may be over multiple symbols depending upon data rate. Symbol mapper 210 performs Quadrature Phase Shift Keying (QPSK) or some other modulation on interleaved data and generates constellations. The constellations are passed to Inverse Fast Fourier Transformation (IFFT) 212 as I and Q components, assigned to subcarriers, and transformed to time domain. A preamble sequence is inserted into the time domain output of IFFT 212 by insert preamble block 213. Block 214 inserts at appropriate times a prefix and a guard interval into the time domain signal containing the preamble. For certain data rates, time spreading is used and symbols are repeated. DAC 216 converts the digital I signal to analog, and DAC 218 performs a similar process for the Q signal. The analog signals generated by DACs 216 and 218 may be passed to a radio for transmission.

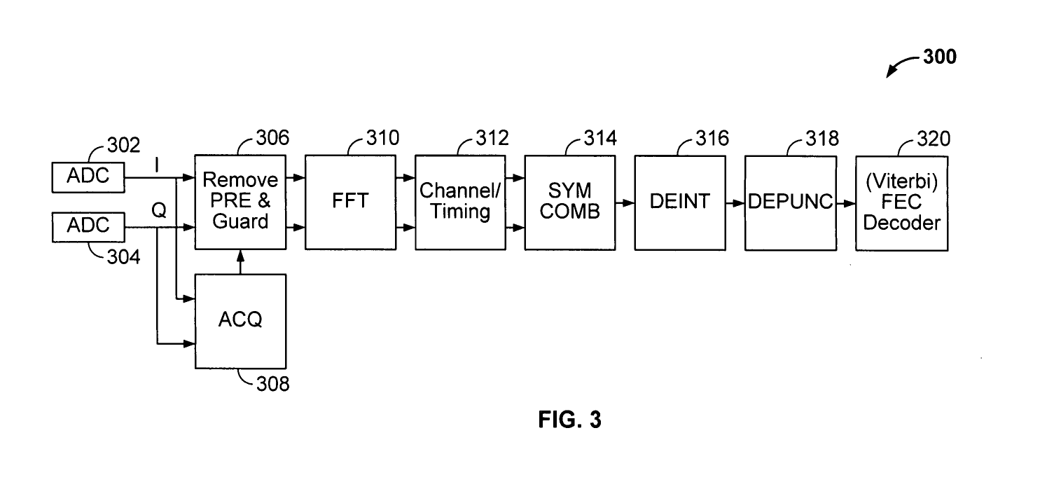

FIG. 3 is a block diagram illustrating an embodiment of a baseband receiver. In the example shown, the baseband receiver is a WiMedia device. As with a baseband transmitter, processing performed may depend upon a data rate. Baseband receiver 300 may receive analog signals from a radio. The analog signals are converted to digital samples using ADC 302 to generate I samples and ADC 304 to generate Q samples. Digital I and Q samples are passed to acquisition block 308 to detect the reception of a frame. Acquisition block 308 indicates to block 306 the start of reception of a frame, and block 306 removes a prefix and a guard interval at appropriate times. FFT 310 transforms the data from time domain to frequency domain. Information transmitted in subcarriers is passed from FFT 310 to channel/timing block 312. Channel/timing block 312 may perform channel estimation, channel equalization, or timing drift correction using overhead information transmitted in the subcarriers, such as pilot tones. Symbol combiner 314 combines time and/or frequency spread symbols, if needed. A variety of adders or averagers may be used. Symbol combiner 314 may also demodulate QPSK or some other constellations. Demodulated data is passed to deinterleaver 316 to reverse the interleaving applied at the transmitter. Depuncturer 318 receives deinterleaved data and inserts an appropriate value, such as an erasure or neutral value, if needed. Forward Error Correction (FEC) Decoder 320 decodes depunctured data from Depuncturer 318.

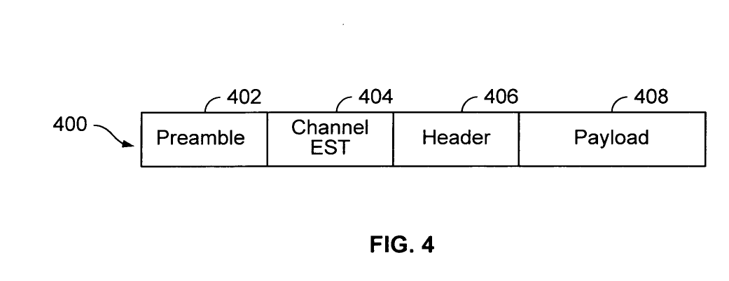

FIG. 4 is a diagram illustrating an embodiment of a frame, portions of which reduced processing is performed on. In the example shown, frame 400 is transmitted by a wireless device and comprises of a variety of portions. Each portion may include symbols, some of which may be predefined symbols. Preamble 402 of frame 400 may be used by a receiver to detect reception of frame 400. For example, acquisition block 308 may process the symbols in preamble 402 to detect the frame. Predefined symbols may be used in preamble 402. Channel estimation 404 follows preamble 402. The channel estimation portion may be used by a receiver to evaluate the wireless channel used. Header 406 follows channel estimation 404 and may include a data rate. A receiver may use the data rate to determine appropriate receiver processing to apply. Payload 408 may include transmit data passed from the transmitter's MAC to the transmitter's baseband.

In some embodiments, a transmitter or receiver performs reduced processing on header 406 and payload 408. For example, performance may improve if all of the data in preamble 402 and channel estimation 404 are processed. Timing, frequency, phase, or channel information that may be used for the duration of frame 400 may be determined from preamble 402 or channel estimation 404. Performance may degrade to an undesirable level in some cases if a subset of data of preamble 402 or channel estimation 404 is processed. In some embodiments, a wireless device performs reduced processing on preamble 402 or channel estimation 404.

Some data rates introduce redundancy in the time domain. Using time spreading, two copies of a symbol are transmitted. Some data rates introduce redundancy in the frequency domain using frequency spreading. A given piece of data and its complex conjugate are assigned to two subcarriers such that they are symmetric about a center frequency. For example, the 100 WiMedia data subcarriers may be indexed −50 to −1 and 1 to 50. Subcarriers −1 and 1 contain a piece of data and its complex conjugate, subcarriers −2 and 2 contain another piece of data and its complex conjugate, etc. The following table illustrates time spreading and frequency spreading associated with some WiMedia data rates.

| Data Rate | Time Spreading | Frequency Spreading |
|---|---|---|
| 53.3 Mbps | Yes | Yes |
| 80 Mbps | Yes | Yes |
| 106.7 Mbps | Yes | No |
| 160 Mbps | Yes | No |
| 200 Mbps | Yes | No |
| 320 Mbps | No | No |

Reduced processing in some embodiments utilizes redundancy in a transmission signal. In some embodiments, reduced processing is performed on redundant symbols inserted from time spreading.

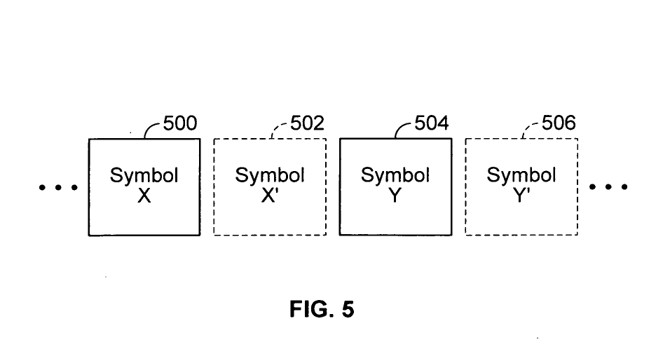

FIG. 5 is a transmission diagram illustrating an embodiment of reduced processing of symbols. In the example shown, a transmitter or a receiver may apply reduced processing to time spread symbols. The symbols may be part of a frame, including the preamble, channel estimation, header or payload portion of a frame. A subset of data including symbols X 500 and Y 504 are processed. Symbols X′ 502 and Y′ 506 are not processed.

In some embodiments, a receiver performs reduced processing on symbols of a frame. For example, symbols 500, 502, 504, and 506 may be transmitted by a wireless device. A receiver may decide to receive and/or process every other symbol. Symbols X 500 and Y 504 may be received and processed by a receiver, whereas symbols X′ 502 and Y′ 506 are not. The symbols that are processed may contain sufficient information to obtain the original transmit data. In some embodiments, components of a baseband receiver, such as baseband receiver 300, do not process data associated with symbols X′ 502 and Y′ 506. If appropriate, some of these components may be powered down during symbols X′ 502 and Y′ 506.

In some embodiments, reduced processing is performed on symbols by a transmitter. Similar to a receiver, data associated with symbols X′ 502 and Y′ 506 may not necessarily be processed or transmitted by a transmitter. There may be a null during the periods corresponding to symbols X′ 502 and Y′ 506. Appropriate components of baseband transmitter 200 may be powered down during this time as well.

In some embodiments, a transmitter or receiver performs reduced processing of symbols only if the data rate uses time and/or frequency spreading. For example, reduced processing of symbols may be employed for 53.3 Mbps, 80 Mbps, 106.7 Mbps, 160 Mbps, and 200 Mbps data rates.

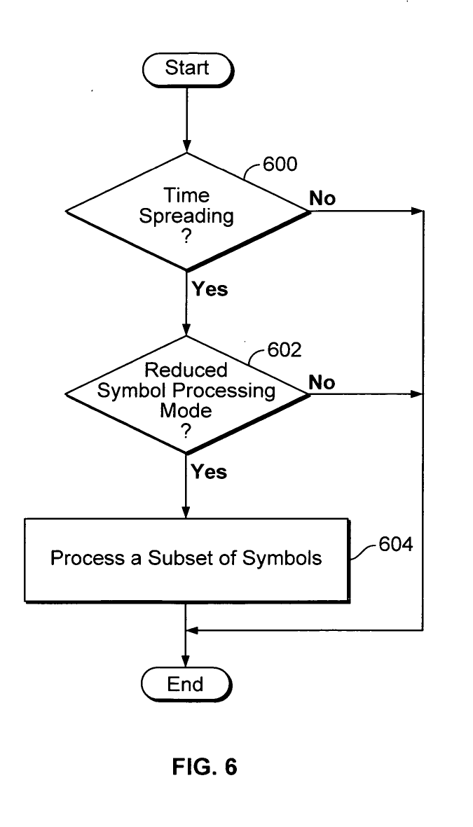

FIG. 6 is a flowchart illustrating an embodiment of reduced processing of symbols. In this example, reduced processing of symbols is employed only for data rates associated with time spreading. However, this is not necessarily a requirement. The described process may be performed by a transmitter or a receiver. At 600, it is determined whether time spreading is used. This may be determined using the data rate of a frame. If time spreading is not used, the process ends.

Otherwise, if time spreading is used it is determined whether to enter a reduced symbol processing mode at 602. There are a variety of considerations that may be evaluated in decision 602. In some embodiments, a performance measurement is considered. If the error rate is below a certain error rate, a wireless device may decide to enter a reduced symbol processing mode. In some embodiments, power consumption is considered. Devices in which power consumption is a concern may decide to enter the reduced symbol processing mode. In some embodiments, wireless devices with a light traffic load enter a reduced symbol processing state. If a frame is retransmitted because of reduced symbol processing, other frames may not necessarily be affected.

A wireless device in some embodiments waits to enter a reduced processing mode until certain portions of a frame are processed. For example, a receiver may wait to process a preamble portion and a channel estimation portion of a frame before entering a reduced processing mode.

If it is determined at 602 to enter a reduced symbol processing mode, a subset of symbols are processed at 604. In some embodiments, a wireless device defaults to a subset of symbols to process. For example, a wireless device may process the first time spread symbol as a default. In some embodiments, there is a comparison of the copies. For example, a measurement of quality (such as signal strength, or signal to noise ratio) may be calculated and compared for the two copies of the time spread symbols. Symbols X 500 and X′ 502 are compared, and symbols Y 504 and Y′ 506 are compared. The better quality symbol of each pair may be included in the subset of symbols to process.

In some embodiments, reduced processing is performed on symbols that are not time spread. In some embodiments, the subset of symbols processed is not limited to be half of the symbols. The subset of symbols processed may be any subset of symbols.

In some embodiments, reduced processing pertains to encoded data. Encoding may introduce redundancy and a subset of encoded data may be processed. Reduced processing pertaining to symbols and reduced processing pertaining to encoded data are not necessarily coupled. A transmitter or receiver may decide to perform reduced processing on symbols, encoded data, or both.

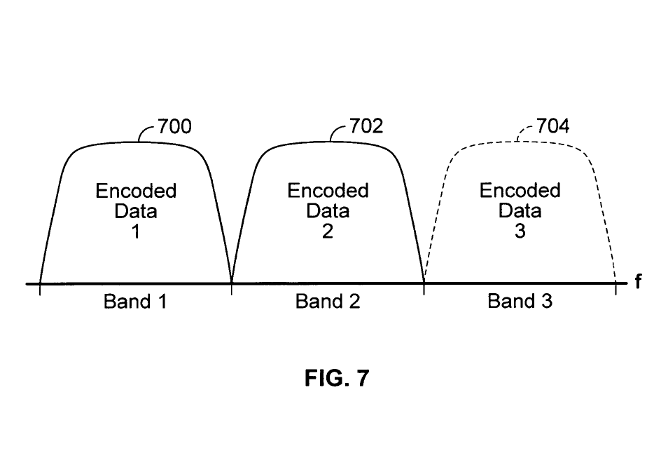

FIG. 7 is a spectrum illustrating an embodiment of reduced processing applied to encoded data. In the example shown, a transmitter or receiver may perform reduced processing on encoded data. A ⅓ code rate is used in this example, where there are three encoded bits generated for every one input bit. At some data rates, such as 53.3 Mbps and 106.7 Mbps, each encoded bit is consistently mapped to the same OFDM symbol when TFI/FFI is used. Encoded data 1 700 may include the first encoded bit generated by an encoder and is transmitted in OFDM symbol 1. The second encoded bit is included in encoded data 2 702 and is transmitted in OFDM symbol 2. Encoded data 3 704 corresponds to the third encoded bit and is transmitted in OFDM symbol 3. A transmitter or receiver may decide to process a subset of encoded data that includes encoded data 1 700 and encoded data 2 702. A wireless device may decide to process a subset of encoded data to save power. If every third encoded bit is discarded, the performance penalty may correspond to using a ½ code rate instead of a ⅓ code rate.

In some embodiments, a transmitter processes encoded data 1 700 and 2 702 as shown. A baseband transmitter may be configured so that puncturer 206 discards encoded bits included in encoded data 3 704. In some embodiments, this may be every third encoded bit output by encoder 204. In some embodiments, discarded encoded bits are replaced with zero values in a transmitter.

A receiver in some embodiments processes a subset of encoded data. Encoded data 3 704 may be transmitted in every third OFDM symbol by a transmitter, but a receiver may decide to not receive and/or not process encoded data 3 704. For example, if encoded data 3 704 includes every third encoded bit, a receiver may turn off a receiving radio and/or baseband during symbols that correspond to encoded data 3 (i.e., every third symbol).

The subset of encoded data processed may be selected in some embodiments. In some embodiments, the subset of encoded data is selected based on coding strength. Three generator polynomials may respectively generate three encoded bits. The encoded bit generated by the weakest generator polynomial may be excluded from the set of encoded data processed. As with a subset of symbols, the subset of encoded data may be any subset of encoded data.

In some embodiments, reduced processing is performed on subcarriers of a band. In some embodiments, either positive or negative subcarriers of a band are processed.

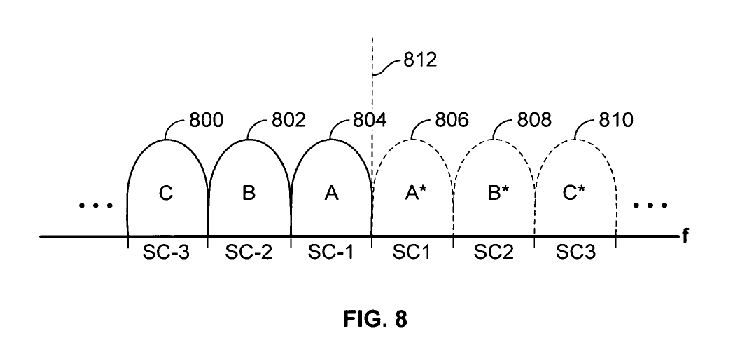

FIG. 8 is a spectrum illustrating an embodiment of reduced processing applied to frequency spread subcarriers. In this example, a data rate associated with frequency spreading, such as 53.3 Mbps or 80 Mbps, is used so that data transmitted in one subcarrier is complex conjugated and transmitted in another subcarrier. The other subcarrier is selected so that the pair is symmetric about center frequency 812. Data A 804 is transmitted in subcarrier −1 and data A* 806 is transmitted in subcarrier 1, where “*” indicates the complex conjugation operation. Similarly, data B 802 and data B* 808 are transmitted in subcarriers −2 and 2, respectively, and data C 800 and data C* 810 are transmitted in subcarriers −3 and 3, respectively.

In this example, the negative subcarriers (i.e., subcarriers below center frequency 812) are processed and the positive subcarriers (i.e., those above center frequency 812) are not. A transmitter or a receiver may process the negative subcarriers as illustrated. In some embodiments, processing a subset of subcarriers, such as half of the subcarriers, may enable a wireless device to consume less power, or may enable smaller wireless devices. Although processing the all of the subcarriers may result in better performance compared to processing the negative subcarriers, the redundancy in the frequency domain may be sufficient to make the power-performance tradeoff worthwhile in some applications.

In some embodiments, a transmitter processes the negative subcarriers below center frequency 812. A transmitter may insert zero values into the positive subcarriers so that nulls are transmitted in those subcarriers. For example, baseband transmitter 200 may be configured so that zero values are inserted into IFFT 212 for the positive subcarriers. This may facilitate components to be eliminated or reduced. The size of interleaver 208 or symbol mapper 210 may be reduced.

In some embodiments, a transmitter communicates to a receiver which subcarriers are nulled. In the example illustrated, a transmitter may indicate the positive subcarriers are nulled. A receiver may use this information to process received data. For example, an erasure or neutral value may be used for a subcarrier transmitted with a null. This may enable a receiver to have a better error rate than if the actual received value is processed. A receiver may also determine to discard data received in subcarrier 1 and not combine it with data received in subcarrier −1.

In some embodiments, a receiver processes negative subcarriers as described. A receiver may process data received in the negative subcarriers and may discard data received in the positive subcarriers. Baseband receiver 300 may be configured so that the outputs of FFT 310 corresponding to the positive subcarriers are not used. In some embodiments, the positive subcarriers are discarded after processing by channel/timing block 312.

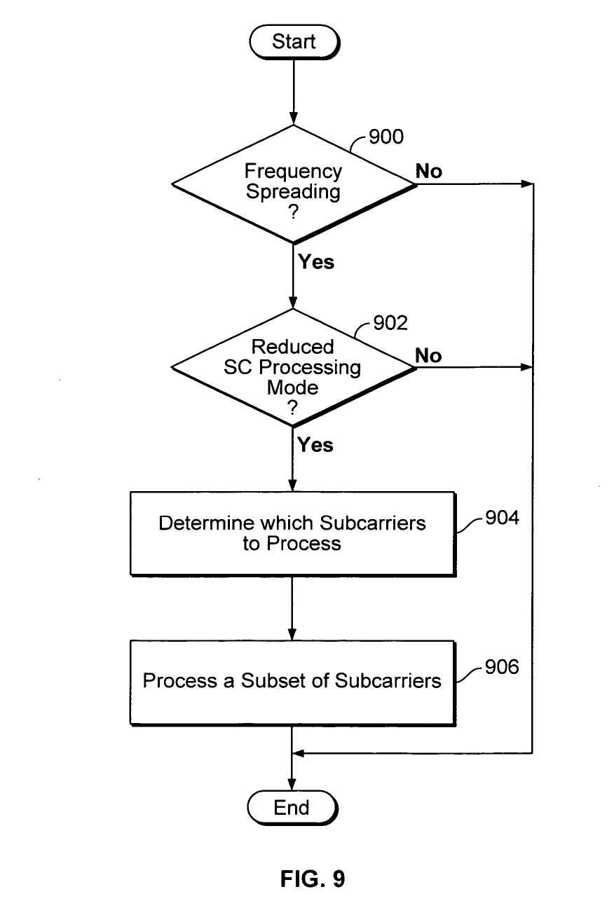

FIG. 9 is a flowchart illustrating an embodiment of reduced processing applied to frequency spread subcarriers. In the example shown, a transmitter or receiver may perform reduced processing. At 900, it is determined whether frequency spreading is used. For example, the data rate of a frame may be obtained and the usage of frequency spreading may be determined from the data rate. In this example, a decision to perform reduced processing of subcarriers is based on whether frequency spreading is used. However, this is not necessarily a requirement. If frequency spreading is not used, the process ends in this example.

If frequency spreading is used, it is decided at 902 whether to enter a reduced subcarrier processing mode. The decision may be based upon a performance measurement. For example, if the current error rate is not satisfactory, it may be decided to not enter a reduced processing mode.

If it is determined to enter a reduced subcarrier processing mode, subcarriers to process are determined at 904. The subset of subcarriers processed may be any subset. In some embodiments, this decision may be based on the presence of another wireless device. The subcarriers not processed may include a band used by another wireless device. In some embodiments, the decision may be based on the transmission environment, such as multipath conditions. In some embodiments, a wireless device decides to process either the positive subcarriers or the negative subcarriers. In some embodiments, subcarriers processed (and conversely, subcarriers that are not processed) are symmetric about the center frequency. If subcarrier −2 is processed then subcarrier 2 is also processed. The number of subcarriers processed do not necessarily need to equal half of the subcarriers. In some embodiments, the subset of subcarriers includes all data subcarriers except for one or two subcarriers.

At 906, a subset of subcarriers is processed. In some embodiments, a transmitter inserts zero values into the non-processed subcarriers and null values are transmitted in those subcarriers. Components that perform transmitter processing may be reduced or eliminated. A receiver in some embodiments processes a subset of subcarriers. Non-processed subcarriers may be discarded by a receiver, and components associated with receiver processing may be reduced or eliminated. Note that the reduced power consumption techniques could be applied to both time spread and frequency spread OFDM symbols. For certain data rates both time/frequency domain spreading is performed at the transmitter. In such cases every alternate OFDM symbol could be processed in order to reduce power consumption, and only half of the sub-carriers of the processed OFDM symbol are processed in order to reduce the power consumption even further.

In some embodiments, a receiver processes an I (Q) signal that contains most of the signal energy and disables a Q (I) path that processes a Q (I) signal. Disabling a Q path may enable reduced power consumption. A receiver may decide to disable a Q path if most of the signal energy is included in the I signal, for example at 53.3 Mbps or 80 Mbps data rates. Tracking methods, used before or after disabling a Q path, may be used to facilitate receiving a signal.

In some wireless systems, both the I and Q signal are processed at the receiver (even when the transmitted signal is purely ‘real’) because a phase relationship between the transmitter and receiver is unknown. This may be the result of non-ideal components in the transmitter and/or receiver, or may be the result of a wireless channel affecting a transmitted signal. A frequency offset is an example of the first, and a channel response is an example of the second. If the mapping between the transmitter's I/Q to the receiver's I/Q domain is known or can be determined relatively easily, it may be possible in some cases to eliminate processing of one of the two baseband channels while operating at an acceptable performance level.

If there is a frequency offset between the local oscillator (LO) of the transmitter and the LO of the receiver, a conjugate-symmetric transmission (where all of the energy is contained in either the I or Q signal), may be perceived at a receiver to have energy alternating periodically between the I signal and the Q signal (where the period may be determined by the magnitude of the frequency offset). Methods to correct for frequency offset may enable acceptable performance even when only one path is processed.

If a channel response happens to be non-symmetric about the center frequency, a ‘real’ transmission may map to a ‘complex’ signal at the receiver. In some cases, the channel may be approximately symmetric, in which case the performance penalty associated with processing only one of the I or Q signals may be acceptable. In other cases, a filter may be used to compensate for the channel distortion and permit processing of only one of the I or Q signals. Using an adjustable filter is one technique to enable a satisfactory level of performance when processing only one path.

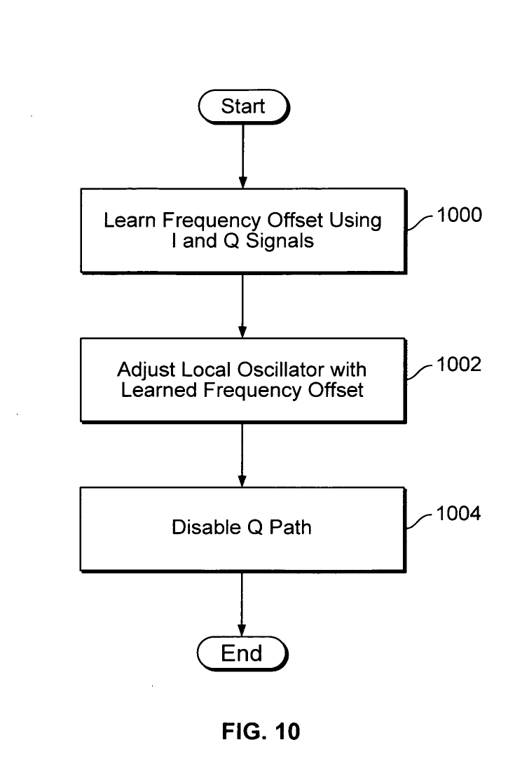

FIG. 10 is a flowchart illustrating an embodiment of disabling a Q path after adjusting a local oscillator. In the example shown, a receiver may be receiving a frame at a data rate of 53.3 Mbps or 80 Mbps. At 1000, a frequency offset using I and Q signals is learned. The frequency offset learned may be due to a frequency offset between the receiver's LO and the transmitter's LO. In some embodiments, preamble 402 of frame 400 may be used to determine the frequency offset.

The learned frequency offset is used to adjust a local oscillator at 1002. For example, if a receiver's local oscillator is running at a faster frequency than a transmitter's local oscillator, the frequency of the receiver's local oscillator may be reduced using the learned frequency offset. Depending on the implementation of the local oscillator, learning the frequency offset at 1000 and adjusting the local oscillator at 1002 may be performed in an iterative manner, perhaps over several packets. As long as the frequency offset is relatively stable, an iterative approach can still allow the system to switch off one of the two baseband paths a significant part of the time.

At 1004, a Q path is disabled. Radio or baseband components associated with a Q path may be disabled. Some or all of radio 106, ADC 304, remove preamble and guard block 306, FFT 310, channel/timing block 312, or symbol combiner 314 may be disabled. Disabling a Q path may occur during a second portion of a frame. Frame 400 may be divided into a first portion and a second portion. During the first portion, the frequency offset is learned and applied. A second portion, during which the Q path is disabled, may include header 406 or payload 408.

In some embodiments, a receiver performs the process illustrated periodically. In some applications, such as Wireless Universal Serial Bus (WUSB), a receiver communicates with only one other wireless device. It may be acceptable to disable a Q path for multiple frames without learning and adjusting the frequency offset. In some embodiments, the process described is performed for each frame. A wireless device may be communicating with multiple wireless devices and a frequency offset is learned and applied for each frame.

In some embodiments, tracking methods are used while a Q path is disabled. Although a frequency offset may be adjusted before a Q path is disabled, timing between a transmitter and a receiver may slowly change while the Q path is disabled. Non-ideal timing components in the transmitter or receiver may be inaccurate or inconsistent. Tracking methods used while a Q path is disabled may correct for this.

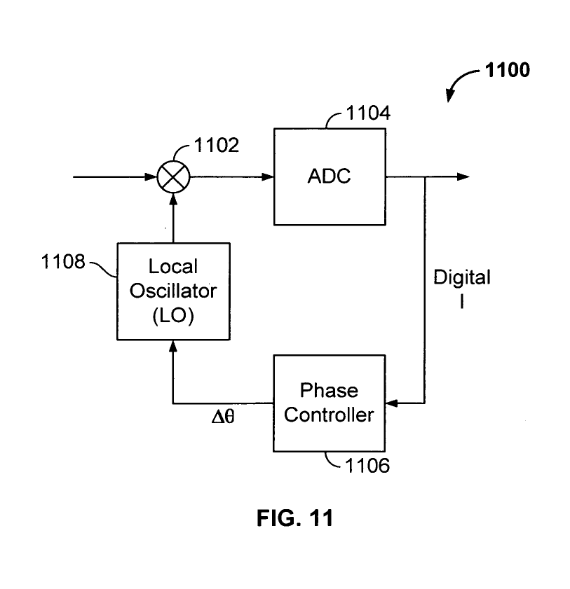

FIG. 11 is a block diagram illustrating an embodiment of a dither loop used to adjust a phase of a receiver's local oscillator. In the example shown, the Q path (not shown) of the receiver is disabled. A dither loop may be used to adjust a receiver when only the I or Q path is processed. In some embodiments, dither loop 1100 continually adjusts the phase of local oscillator (LO) 1108. In some embodiments, dither loop 1100 is included in a radio of a receiver.

Signal combiner 1102 processes a received signal transmitted on a band of the wireless medium. A reference clock received from local oscillator 1108 may be approximately equal to the center frequency of the band. The frequency of local oscillator 1108 may be tuned to the frequency of a transmitter's local oscillator. Signal combiner 1102 combines the received signal with the reference clock to generate an analog I signal. In some embodiments, a filter may be included in dither loop 1100.

The analog I signal is passed from signal combiner 1102 to ADC 1104. ADC 1104 generates a digital I signal from the analog signal. The digital I signal is passed to phase controller 1106. Phase controller 1106 may adjust the phase of LO 1108 and observe the resulting digital I signal. The signal Δθ may be changed to maximize the power of the I signal from ADC 1104. In some embodiments, phase controller 1106 dithers the Δθ signal so that a range of phases are passed to LO 1108. The Δθ value within the range that produces the maximum power may be identified and used. In some embodiments, there is a period of time during which Δθ is fixed to a value that produced the maximum power.

Using a dither loop may improve performance of a receiver that disables its Q path. Although the timing between a transmitter and a receiver may change, the dither loop may adjust the timing of the receiver's local oscillator to track this change. Without a dither loop, signal energy may slowly shift from the I signal to the Q signal at a receiver. Since the Q signal is not processed, the performance of the receiver may degrade.

A receiver may learn the distortion of the signal due to channel response. With this information, a receiver may: accept a performance penalty (in return for reduced power consumption) and process only one baseband channel; insert an analog filter to make the baseband signal more closely map to a single channel and process only one baseband channel; or accept the higher power consumption and process both channels. A choice between these options may depend on receiver complexity and the channel encountered for a particular link.

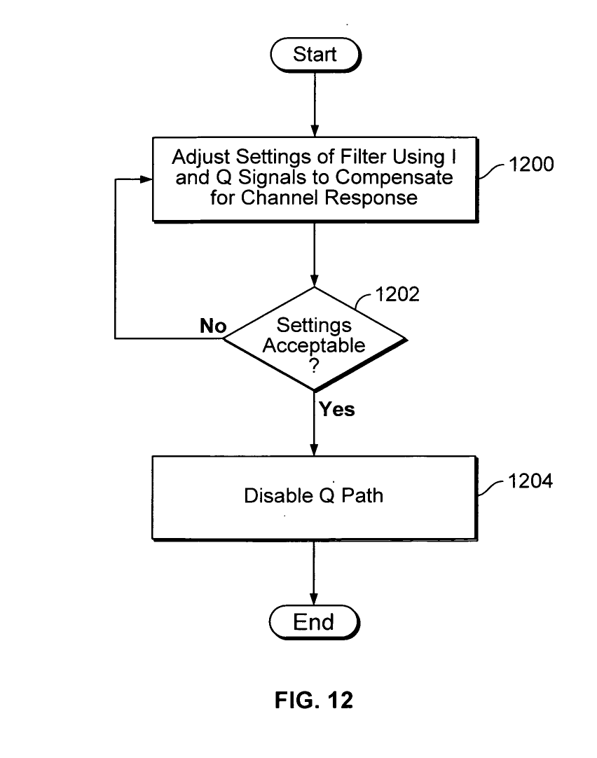

FIG. 12 is a flowchart illustrating an embodiment of disabling a Q path after adjusting a filter. In the example shown, a receiver may be receiving a frame at a data rate of 53.3 Mbps or 80 Mbps. Frames at these data rates may have most of their energy either in the I signal or the Q signal, but some wireless channels may cause this distribution of energy to shift. A filter may be used at a receiver to compensate for a channel response. In some embodiments, the filter is an adjustable, analog filter used before quadrature down conversion.

At 1200, the settings of a filter are adjusted using I and Q signals to compensate for a channel response. The settings may correspond to attenuating particular frequencies processed by the filter and each frequency may be attenuated to a different degree. At 1202, it is decided whether the settings are acceptable. Acceptable settings are settings that increase the power of one signal to a sufficient degree. Considerations associated with a particular application (such as a desired error rate, design complexity, or a desired power consumption) may be considered. The signal for which power is increased may be the signal with the larger power initially. If the settings are not acceptable, the settings are adjusted at 1200. Otherwise, the Q path is disabled at 1204.

In some cases an acceptable setting maximizes the power of one of the two signals. Maximizing the power of either the I or Q signal may correspond to adjusting the filter so that a filtered output that is symmetric about the center frequency results. Filtering may compensate for a channel response that is non-symmetric about the center subcarrier. With a non-symmetric channel response, both the I and Q signals may contain signal energy (as opposed to only one of the signals) even if a frame at 53.3 Mbps or 80 Mbps is received.

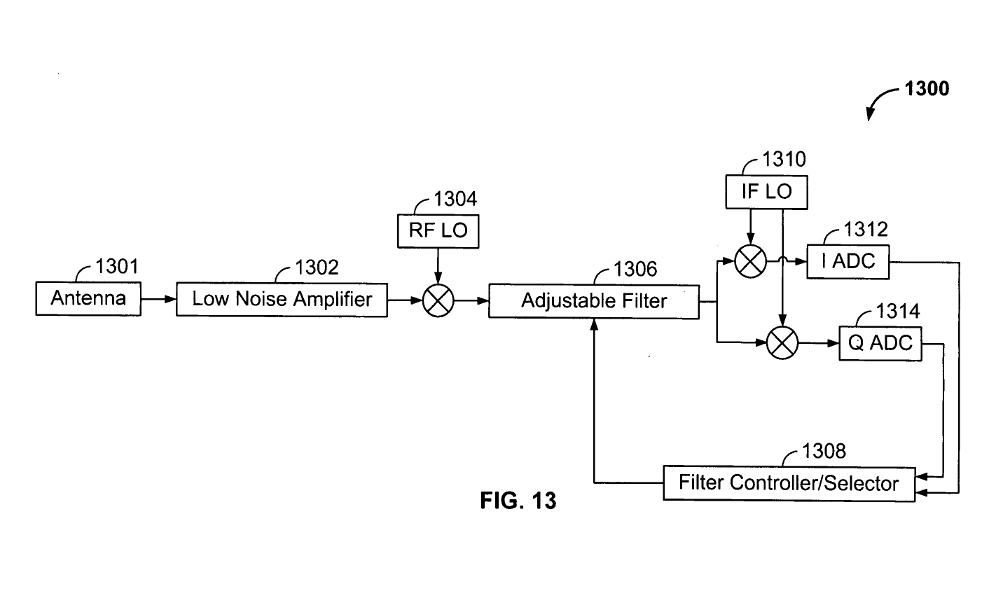

FIG. 13 is a block diagram illustrating an embodiment of a radio receiver that uses an adjustable filter to compensate for a channel response. In the example shown, a filter controller adjusts a filter when frames at 53.3 Mbps or 80 Mbps are received so that an acceptable level of performance is maintained while the Q path is disabled. A signal is received by antenna 1301, which is coupled to low noise amplifier (LNA) 1302. LNA 1302 amplifies the received signal from antenna 1301, and the amplified signal is mixed with the output of radio frequency (RF) local oscillator (LO) 1304. An intermediate signal results from the mixing and is passed to adjustable filter 1306. Adjustable filter 1306 could be implemented as a bank of discrete filters, as a tapped-delay line, or as an adjustable network of passive or active components.

The settings of filter 1306 are adjusted by filter controller/selector 1308. Controller 1308 examines the digital I and Q signals generated by ADCs 1312 and 1314, respectively. The analog I and Q signals that are processed by ADCs 1312 and 1314, respectively, are generated by mixing the output of adjustable filter 1306. The filtered signal from adjustable filter 1306 is mixed with a first output and a second output from intermediate frequency (IF) local oscillator (LO) 1310. The first output and second output of IF LO 1310 have a phase difference of 90°. An analog I signal and an analog Q signal result from mixing the filtered signal with the outputs of IF LO 1310.

In some embodiments, a receiver includes a dither loop and an adjustable filter. Before the Q path is disabled, the LO is adjusted for the frequency offset and the adjustable filter is adjusted for the channel response. A receiver may wait to disable the Q path until both the LO and the adjustable filter are appropriately set. After the Q path is disabled, the dither loop may be used to adjust the receiver.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of operating a signal processor, comprising:
simultaneously operating a first signal processor and a second signal processor, wherein the first signal processor is associated with processing a first component of a signal received via a wireless medium, and the second signal processor is associated with processing a second component of the signal received via the wireless medium;
determining whether to suspend operation of the second signal processor; and
suspending operation of the second signal processor.

2. A method as recited in claim 1, wherein the method is performed by an ultrawideband (UWB) wireless device.

3. A method as recited in claim 1, wherein:
simultaneously operating the first signal processor and the second signal processor occurs during a first portion of a frame; and
suspending operation occurs during a second portion of the frame.

4. A method as recited in claim 1, wherein the first component has significantly more signal energy than the second component.

5. A method as recited in claim 1, further including resuming operation of the second signal processor.

6. A method as recited in claim 1, wherein the first component includes an I signal.

7. A method as recited in claim 1, wherein the second component includes a Q signal.

8. A method as recited in claim 1, wherein the second signal processor includes an analog to digital converter (ADC).

9. A method as recited in claim 1, wherein the second signal processor includes a radio related component.

10. A method as recited in claim 1, wherein the second signal processor includes a baseband related component.

11. A method as recited in claim 1, wherein the method facilitates reduced power consumption.

12. A method as recited in claim 1, wherein determining whether to suspend operation is based at least in part on a data rate.

13. A method as recited in claim 1, wherein suspending operation includes powering down the second signal processor.

14. A method as recited in claim 1 further including adjusting, while the first signal processor and the second signal processor are operated simultaneously, a clock used to obtain the first component.

15. A method as recited in claim 1 further including adjusting, while the first signal processor and the second signal processor are operated simultaneously, a clock used to obtain the first component, including adjusting the clock's frequency.

16. A method as recited in claim 1 further including adjusting, while the first signal processor and the second signal processor are operated simultaneously, a filter to increase signal energy contained in the first component.

17. A method as recited in claim 1 further including adjusting, while the first signal processor and the second signal processor are operated simultaneously, a filter to increase signal energy contained in the first component; and wherein determining whether to suspend operation is based at least in part on the signal energy contained in the first component.

18. A method as recited in claim 1 further including adjusting, while operation of the second signal processor is suspended, a clock used to obtain the first component.

19. A method as recited in claim 1 further including adjusting, while operation of the second signal processor is suspended, a clock used to obtain the first component, including adjusting the clock's phase.

20. A method as recited in claim 1 further including adjusting, while operation of the second signal processor is suspended, a clock used to obtain the first component, including:
applying an adjustment to the clock;
observing signal energy of the first component resulting from the adjustment; and
determining whether to continue using the adjustment.

21. A method as recited in claim 1 further including adjusting, while operation of the second signal processor is suspended, a clock used to obtain the first component, including:
applying a plurality of adjustments to the clock;
observing signal energies of the first component resulting from the plurality of adjustments; and
determining which of the plurality of adjustments resulted in a maximum signal energy.

22. A system for operating a signal processor, comprising:
a processor configured to:
simultaneously operate a first signal processor and a second signal processor, wherein the first signal processor is associated with processing a first component of a signal received via a wireless medium, and the second signal processor is associated with processing a second component of the signal received via the wireless medium;
determine whether to suspend operation of the second signal processor; and
suspend operation of the second signal processor.

23. A system as recited in claim 22, wherein the first component has significantly more signal energy than the second component.

24. A system as recited in claim 22, wherein the processor is configured to determine whether to suspend operation based at least in part on a data rate.

25. A system as recited in claim 22, wherein the processor is further configured to adjust, while the first signal processor and the second signal processor are operated simultaneously, a clock used to obtain the first component.

26. A system as recited in claim 22, wherein the processor is further configured to adjust, while operation of the second signal processor is suspended, a clock used to obtain the first component.

27. A computer program product for operating a signal processor, the computer program product being embodied in a computer readable medium and comprising computer instructions for:
simultaneously operating a first signal processor and a second signal processor, wherein the first signal processor is associated with processing a first component of a signal received via a wireless medium, and the second signal processor is associated with processing a second component of the signal received via the wireless medium;
determining whether to suspend operation of the second signal processor; and
suspending operation of the second signal processor.

28. A computer program product as recited in claim 27, wherein the first component has significantly more signal energy than the second component.

29. A computer program product as recited in claim 27, wherein determining whether to suspend operation is based at least in part on a data rate.

30. A computer program product as recited in claim 27, the computer program product further comprising computer instructions for adjusting, while the first signal processor and the second signal processor are operated simultaneously, a clock used to obtain the first component.

31. A computer program product as recited in claim 27, the computer program product further comprising computer instructions for adjusting, while operation of the second signal processor is suspended, a clock used to obtain the first component.
